(19) United States
(12) Patent Application Publication
(10) Pub. No.: US 2003/0159912 A1
(43) Pub. Date: Aug. 28, 2003

(54) Switch device

(75) Inventor: Makoto Sasaki, Miyagi-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/376,613

(22) Filed: Feb. 27, 2003

(30) Foreign Application Priority Data
Feb. 28, 2002 (JP) 2002-053854

(51) Int. Cl. H01H 21/00

(52) U.S. Cl. 200/553

(57) ABSTRACT

A downsizable and cost-effective switch device is provided. The switch device of the invention includes: a case having a bottom wall and sidewalls; a fixed contact member; a movable contact member; a driving member mounted on the sidewalls; and restoring means for restoring the driving member to the original position, the driving member including an actuating portion for moving the movable contact member and an operating portion for rotating the actuating portion, wherein the actuating portion moves the movable contact member and brings the movable contact member into contact with the fixed contact member when the operating portion is driven, and the driving member is restored to the original state in which the movable contact member and the fixed contact member are brought out of contact by restoring means when the driven state of the operating portion is released.

### BACKGROUND OF THE INVENTION

1. Field of the Invention

The present invention relates to a switch device, and, more specifically, to a switch device suitable to be used for driving an on-vehicle power window apparatus.

2. Description of the Related Art

A switch device in the related art will be described referring to attached drawings. FIG. 18 is. an exploded perspective view showing the switch device in the related art, and FIG. 19 is a cross. sectional view showing the switch device in the related art.

The switch device in the related art is a so-called bipolar/double-throw switch device having two switch element sets.

An enclosure 81 includes a substantially box-shaped case 82 and a plurality of fixed contact members 83 formed in the case 82 of metallic material by insert molding so as to extend partly outward from the case 82.

The case 82 includes a bottom wall 82a, sidewalls 82b surrounding four sides, a partitioning wall 82c disposed in parallel with one of opposing sidewalls 82b, and two openings 82d formed on top of the sidewalls 82b and the partitioning wall 82c.

The fixed contact member 83 includes a first, a second and a third fixed contact points (not shown), and a first, a second and a third terminals 83a, 83b and 83c extend outward from the first, the second and the third fixed contact points (not shown) respectively.

The fixed contact member 83 is formed by insert molding on the bottom wall 82a of the case 82, so that the first, the second and the third fixed contact points (not shown) are partly exposed. from the surface of the bottom wall 82a, and the first, the second and the third terminals 83a, 83b and 83c extends outward from one of the sidewalls 82b.

Two (two pairs of) fixed contact members 83 are disposed symmetrically with respect to the case 82.

A movable contact member 84 is formed symmetrically in a substantially M-shape, and includes a first movable contact point 84a located at the center of the M-shape, and a second and a third movable contact points 84b and 84c provided at both free ends so as to interpose the first movable contact point 84a therebetween.

The movable contact member 84 is disposed in such a manner that the first movable contact point 84a is in contact with the upper surface of the first fixed contact point (not shown), the second movable contact point 84b is opposed to the second fixed contact point (not shown), and the third movable contact point 84c is opposed to the third fixed contact point (not shown).

In other words, the movable contact member 84 is stored in the case 82.

Two pieces of the movable contact members 84 are respectively disposed on the fixed contact members 83 as described above.

The movable contact member 84 is further disposed so as to be capable of a seesaw movement about the first movable contact point 84a.

A driving member 85 includes a substantially box-shaped base portion 85a and a pair of semi-cylindrical (semi-circular) driving portions 85b disposed at the lower end of the base portion 85a.

The driving member 85 is disposed in such a manner that the distal ends of the driving portions 85b are in contact with the first movable contact points 84a at the center of the M-shape of the movable contact members 84 respectively.

A lid member 86 includes a rectangular upper wall 86a, sidewalls 86b surrounding four sides of the upper wall 86a, mounting portions 86c extending upward from the center-between the one of opposing sidewalls 86b, through holes 86d formed coaxially on the pair of mounting portions 86c in the vicinity of the upper ends thereof, and a rectangular opening 86e formed between the pair of mounting portions 86c.

The lid member 86 engages the upper portion of the case 82 with suitable means such as snap engagement and the like so that the upper wall 86a thereof covers the two openings 82d of the case 82. In this case, the base portion 85a of the driving member 85 is disposed in the opening 86e of the lid member 86.

The spring member 87 is constructed of a so-called coil spring, and the spring member 87 is disposed by suitable means in the base portion 85a of the driving member 85.

An operating tab member 88 includes a rectangular tab portion 88a, a rectangular storage section 88b extending downward from the center of the tab portion 88a and being surrounded along four sides, and a pair of cylindrical projections 88c projecting outward from one of the opposing outer surfaces of the storage section 88b.

An operating tab member 88 is disposed in such a manner that the storage section 88b is inserted into the opening 86e of the lid member 86, and the driving member 85 provided with a spring member 87 is disposed in the storage section 88b.

The pair of projections 88c of the operating tab member 88 are inserted into and attached to the respective through holes 86d.

In this state, the driving portion 85b of the driving member 85 urges the first movable contact point 84a of the movable contact member 84 toward the first fixed contact point (not shown) of the fixed contact member 83 by a resilient force of the spring member 87.

The operating tab member 88 is adapted to be capable of a swinging motion (clockwise or counterclockwise) about the pair of projections 88c, and this swinging motion of the operating tab member 88 allows the driving member 85 to swing.

By such swinging motion of the driving member 85, the pair of driving portions 85b of the driving member 85 brings the movable contact member 84 formed into the M-shape into a seesaw motion, and such seesaw motion of the movable contact member 84 brings the second or the third movable contact point 84b or 84c of the movable. contact member 84 into and out of contact with the second or the third fixed contact point (not shown) of the fixed contact member 83.

However, in the switch device in the related art, a relatively large lid member is disposed on the case, and the operating tab member is attached on the lid member for a swinging motion. Therefore, it has a problem in that the entire construction of the switch device is upsized.

In addition, in the switch device in the related art, since the number of the components increases and thus the number of steps for assembly.increases as well, the cost increases disadvantageously, and thus the cost-effective switch device cannot be provided.

Further more, since the spring member has to be built in the operating tab member in advance, it is not easy to assemble.

### SUMMARY OF THE INVENTION

Accordingly, it is an object of the invention is to provide a switch device wherein easy assembly, downsizing, and reduction in thickness are realized..

The switch device of the invention includes: a case having a bottom wall and at least an opposing pair of sidewalls extending from the bottom wall; a fixed contact member provided on the bottom wall of the case; a movable contact member disposed in the case; a driving member rotatably mounted on the pair of sidewalls; and restoring means for restoring the driving member to the original position, the driving member including an actuating portion for moving the movable contact member and an operating portion for rotating the actuating portion, wherein the actuating portion is rotated when the operating portion of the driving member is driven and hence the actuating portion moves the movable contact member so that the movable contact member is brought into contact with a fixed contact member, and the driving member is restored to the original position in which the movable contact member and the fixed contact member are brought out of contact by a restoring means when the driven state of the operating portion is released.

In the switch device in the related art, since the spring member for resiliently pressing the movable contact member is disposed in the resiliently pressurized state between the operating tab member and the driving member, and thus the operating tab member is an inevitable component, which requires six components (the number of components). On the other hand, in the construction described above, the operating tab member is not disposed in the normal state of this switch device, and thus it may be constructed of four components (the number of components) including the driving member rotatably mounted on the sidewall and the restoring means for restoring the driving member to the original position. Since the number of components is small, the switch device that may be easily assembled and may be downsized is realized.

In the present switch device in this arrangement, since the operating tab for operating the switch device may be disposed separately from the switch device, the switch device may be standardized, and thus cost-cutting owing to volume efficiency is achieved.

The switch device according to the invention is characterized in that the restoring means is constructed of a spring member.

In this arrangement, such spring member contributes to provide a cost-effective switch device that may easily be formed.

The switch device according to the invention is characterized in that the driving member is urged by the spring member toward the bottom wall, and the driving member is restored to the original state by an urging force of the spring member.

In this arrangement, since the layout and the operations of the driving member and the spring member are simple, the switch device which is simple in construction and hence is cost-effective may be provided.

The switch device according to the invention is characterized in that the spring member is formed of a plate having spring characteristics.

In this arrangement, since the spring member may be formed by pressing, and hence the spring member may easily be formed, the cost-effective switch device may be provided.

The switch device according to the invention is characterized in that the case includes a sidewall surrounding four sides and an opening formed on top thereof, and that the opening is covered by the spring member formed of a plate.

In this arrangement, since the case is hermetically closed by the sidewall and the spring member, foreign substances may be prevented from being entered into a switching element, and thus the switch device having a stable performance may be provided.

The switch device according to the invention is characterized in that the spring member is snap engaged with the sidewall of the case.

In this arrangement, the reliable switch device that is easy to assemble and is reliable may be provided.

The switch device according to the invention is further characterized in that the driving member moves away from the bottom wall against an urging force of the spring member when the actuating portion of the driving member rotates, and simultaneously, the driving elements rotate so that the actuating portion moves the movable contact member to bring the movable contact member and the fixed contact member into contact with each other, while the driving member is restored to the original state by the spring member to bring the movable contact member out of contact with the fixed contact member when the rotation of the driving member is released.

In this arrangement, since the action of the spring member is simple, the switch device in which the driving member can be operated smoothly, and thus the performance is stable may be provided.

The switch device according to the invention is characterized in that the case is provided with a stopper for limiting the rotatable range of the operating portion of the driving member.

In this arrangement, since the rotatable range of the operating portion is limited by the stopper, the switch device in which the rotatable range is stable, thereby achieving reliable operation is provided.

The switch device according to the invention is characterized in that the operating portion of the driving member is positioned outside the case and the stopper is disposed outside the case, so that the operating portion abuts against the stopper to limit the rotational movement thereof.

In this arrangement, since the operating portion is positioned outside the case, the switch device in which the operation of the operating portion may be facilitated and thus the operation and the construction is simple is provided.

The switch device according to the invention is provided with a projection on one of the driving member and the opposing sidewalls of the case, and a recessed portion on the other one of them and a projection in the recess, so that the driving member is rotatably mounted on the case.

In this arrangement, the driving member may be attached easily on the case, and thus the cost-effective switch device that can easily be assembled is provided.

The switch device according to the invention is characterized in that the driving member is formed with a projection, the case is formed with a recess, and the projection is disposed into the recess so that the driving member is rotatably mounted to the case.

In this arrangement, since it is easier to form the projection on the driving member and the recess on the case, the cost-effective switch device that can easily be assembled is provided.

The switch device according to the invention is characterized in that the upper end of the sidewall is provided with a recess opened on top, and the projection is fitted into the recess from above.

In this arrangement, since the projection may be fitted from above, the cost-effective switch device that may be assembled further easily is provided.

The switch device according to the invention is characterized in that the recess on the sidewall is formed to have an almost same width as the diameter of the projection on the driving member, and the projection is adapted to be movable in the vertical direction in the recess.

In this arrangement, since the projection of the driving member is movable in the vertical direction in the recess, the switch device in which the projection is not subject to an excessive force, and thus a stable performance may be maintained for a long time is provided.

The switch device according to the invention is characterized in that the movable contact member includes a flat portion, a rising portion extending from one of the ends of the flap portion in a tilted state, and a contact portion extending from one of the ends of the rising portion and coming into and out of contact with the fixed contact member, and the movable contact member is supported so as to be capable of a seesaw movement.

In this arrangement, since the movable contact member is adapted to be capable of a seesaw movement, and is formed asymmetrically, the switch device in which the direction of the movable contact member may be identified when disposing it on the fixed contact member, and thus reliable assembly is ensured is provided.

The switch device according to the invention is characterized in that the movable contact member performs a seesaw movement by the pressure of the actuating portion being displaced from the flat portion to the rising portion so that the movable contact member is brought into contact with the fixed contact member, and performs a seesaw movement to be restored to the original state by the pressure of the actuating portion being displaced from the rising portion to the flat portion so that the movable contact member is brought out of contact with the fixed contact member.

In this arrangement, since the seesaw movement of the movable contact member may be performed by a simple action of the actuating portion of the driving member, the switch device ensuring a reliable action is provided.

The switch device according to the invention is characterized in that the fixed contact member is constantly in contact with themovable contact member, and includes a first fixed contact point for supporting the movable contact member, and a second fixed contact point for coming into and out of contact with the movable contact member, and in that the movable contact member is adapted to perform a seesaw movement about the first fixed contact point.

In this arrangement, since the fulcrum of the seesaw movement of the movable contact member is set to the first fixed contact point, a simple construction in which the first fixed contact point and the movable contact member are constantly in contact with each other is achieved, and thus the cost-effective switch device is provided.

The switch device according to the invention is characterized in that the fixed contact member includes a third fixed contact point, and the movable contact member is brought into contact with the first fixed contact point and the third fixed contact point and thus the portion between the first and the third fixed contact points is in the ON state when the driving member is not in operation, while the flat portion of the movable contact member is brought out of contact with the third fixed contact point and thus the portion between the first and the third fixed contact points is in the OFF state, and simultaneously the movable contact member is bought into contact with the second fixed contact point so that the portion between the first and the second fixed contact points is in the ON state when the driving member is actuated.

In this arrangement, the cost-effective monopolar/double-throw switch device including small number of components is provided.

The switch device according to the invention is characterized in that a switch element set is constructed of the fixed contact member, the movable contact member, the driving member, and the restoring means, and two switching element sets are disposed in parallel in the case.

In this arrangement, the cost-effective bipolar/double-throw switch device including small number of components and thus being easy to assemble is provided.

The switch device according to the invention is characterized in that the two movable contact members constituting a part of the two switching element sets are disposed alternately with respect to the case so that the flat portions of the respective movable contact members are oriented in the opposite directions.

In this arrangement, since the asymmetric two movable contact members are disposed alternately with respect to the case, the longitudinal dimension of the case may be shortened, and thus the downsizable switch device is provided.

The switching device according to the invention further includes a spring member formed of a plate, and is characterized in that the spring member includes a slit and a first and a second spring portions located at both sides of the slit, the first and the second spring portions are disposed so as to cover the upper portion of the case, and one of the driving member constituting a part of the two switching element sets is pressurized by the first spring portion and the other driving member is pressurized by the second spring portion.

In this arrangement, the first and the second spring portions may operate one or the other one. of the driving members separately, the operating method may be diversified and thus the multifunction switch device is provided.

### BRIEF DESCRIPTION OF THE DRAWINGS

FIG. 1 is an exploded perspective view showing a first embodiment of the switch device according to the invention;

FIG. 2 is a perspective view showing the first embodiment of the switch device according to the invention;

FIG. 3 is a plan view showing.an embodiment of a case and a fixed contact member relating to the switch device according to the invention;

FIG. 4 is a plan view of the switch device according to the invention, showing a state in which a spring member is removed from the switch device;

FIG. 5 is a perspective view showing an embodiment of the driving member relating to the switch device according to the invention;

FIG. 6 is a cross sectional view taken along the line 6-6 in FIG. 2;

FIG. 7 shows the switch device according to the invention, and is a partly cross sectional front view illustrating the switch device and a tab member for operating the switch device;

FIG. 8 shows the switch device according to the invention, and is a partly cross sectional side view illustrating the switch device and the tab member for operating the switch device;

FIG. 9 is a first explanatory drawing illustrating the action of the switch device according to the invention;

FIG. 10 is a cross sectional view for explaining the action of the switch device according to the invention;

FIG. 11 is a second explanatory drawing illustrating the action of the switch device according to the invention;

FIG. 12 is an exploded perspective view showing a second embodiment of the switch device according to the invention;

FIG. 13 is an exploded perspective view showing a third embodiment of the switch device according to the invention;

FIG. 14 is an exploded perspective view showing a fourth embodiment of the witch device according to the invention;

FIG. 15 is a cross sectional view showing a fifth embodiment of the switch device according to the invention;

FIG. 16 is a first cross sectional view showing a sixth embodiment of the switch device according to the invention; FIG. 17 is a second cross sectional view of the sixth embodiment of the switch device according to the invention;

FIG. 18 is an exploded perspective view showing the switch device in the related art; and

FIG. 19 is a cross sectional view showing the switch device in the related art.

### DESCRIPTION OF THE PREFERRED EMBODIMENTS

Referring now to the drawings, embodiments of the invention will be described.

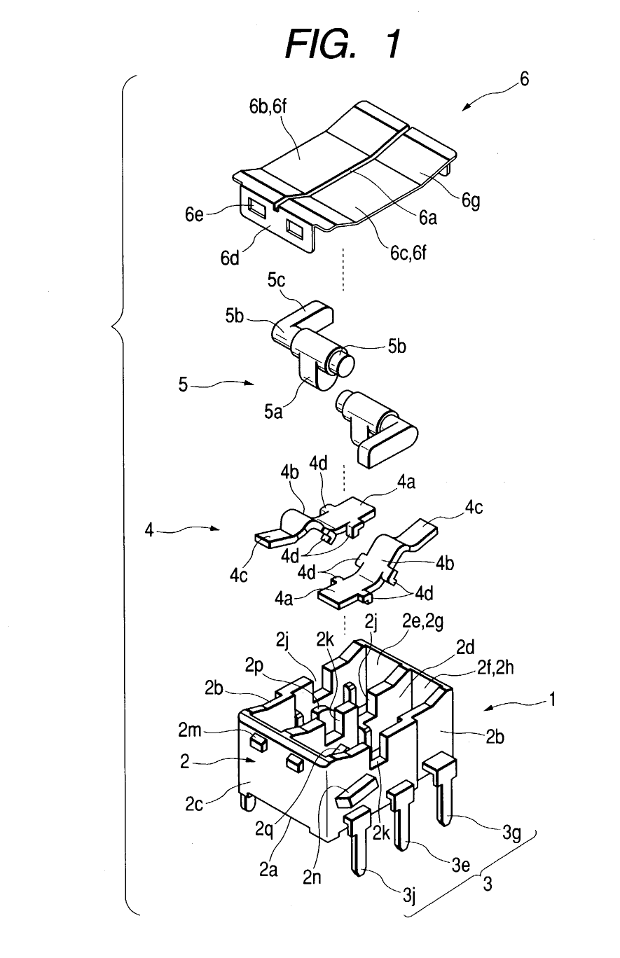

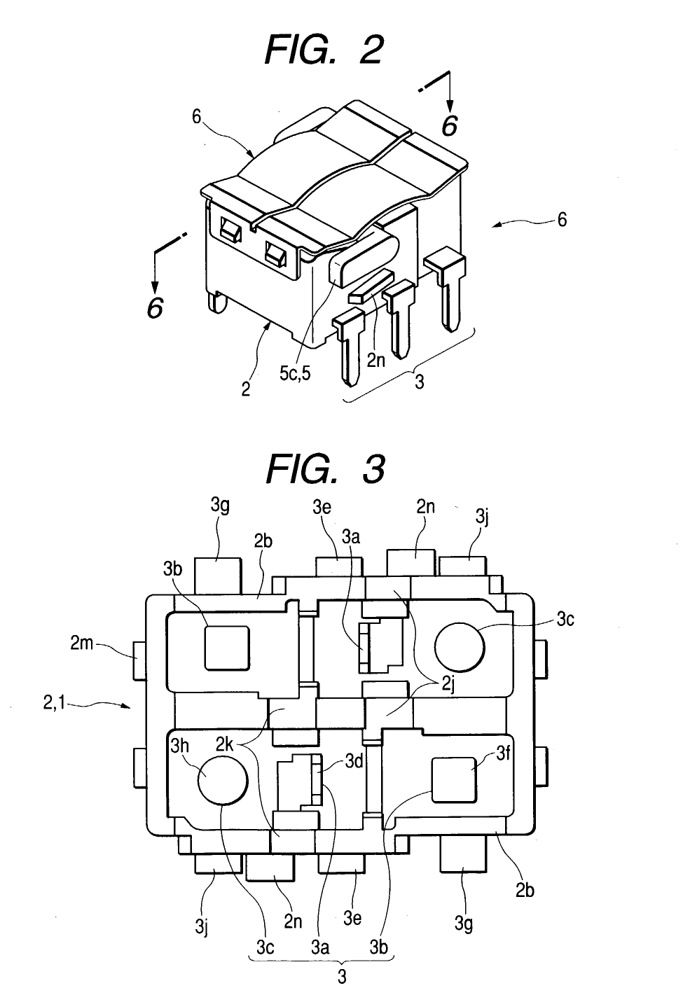

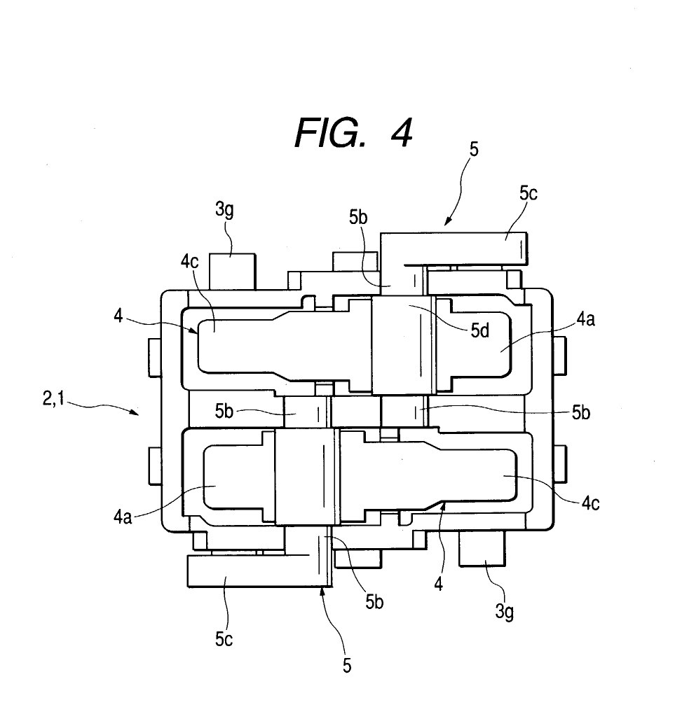

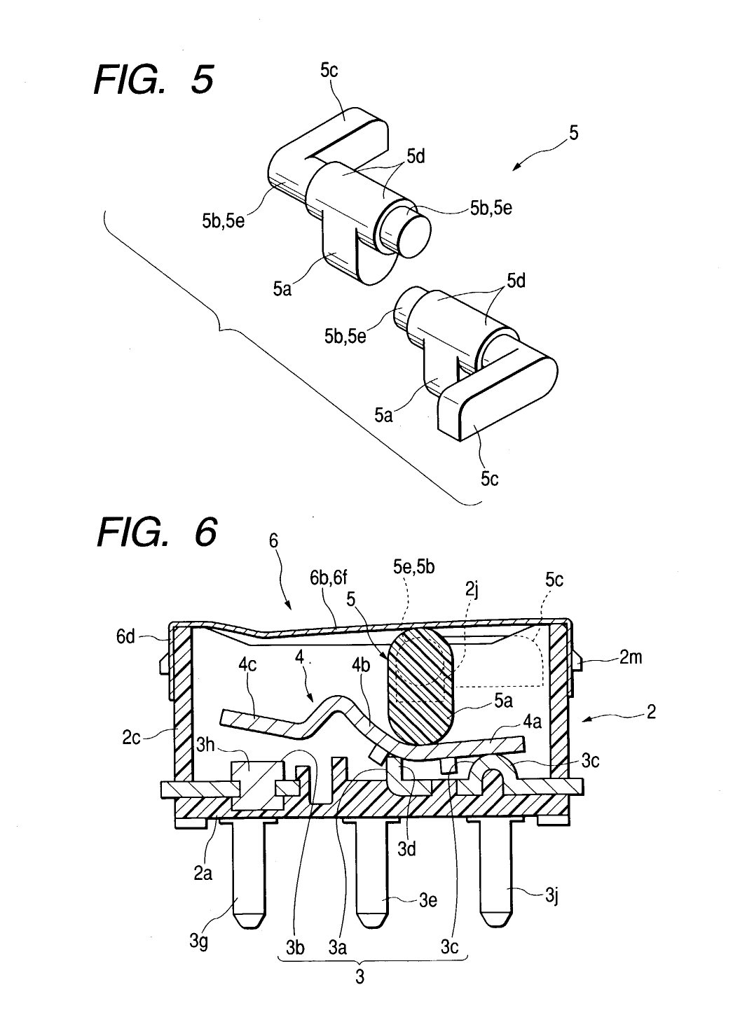

Referring to FIG. 1 to FIG. 6, an enclosure 1 is formed of insulative synthetic resin material and includes a substantially box shaped case 2 formed by molding, and. a plurality of sets of fixed contact members 3 formed in the case 2 by insert molding of metallic material so as to extend partly outward from the case 2.

The case 2 includes a. rectangular bottom wall 2a, first sidewalls 2b, which are one of the opposing sidewalls, extending forward from the bottom wall 2a, second sidewalls 2c which are the other one of the opposing sidewalls, third. sidewalls 2d disposed at a substantially midpoint between the opposing first sidewalls 2b, a first opening 2e, a second opening 2f disposed in parallel with the first opening 2e. A sidewall surrounding four sides is constructed of the first sidewall 2b and the second sidewall 2c and two first and second storage sections 2g and 2h are formed by the third sidewall 2d in the case 2.

The pair of the first sidewalls 2b and the third sidewall 2d are formed with pairs of recesses 2j and 2k opened on top of the first and the third sidewalls 2b and 2d.

The axial lines of the one pair of recesses 2j and the other pair of recesses 2k extend in the direction orthogonal to the inner and outer side surfaces of the first and the third sidewalls 2b and 2d and in parallel with each other.

In other words, one pair of the recesses 2j are disposed coaxially with each other on one of the first sidewalls 2b and the third sidewall 2d, and the other pair of recesses 2k are disposed coaxially with each other on the other one of the pair of first sidewalls 2b and the third sidewall 2d.

Therefore, the third sidewall 2d is formed with one of the recesses 2j and one of the recesses 2k side by side in parallel with each other.

On the opposing pair of first sidewalls 2b on the outer surfaces, there are formed a pair of stopper 2n in the vicinity of the respective recesses 2j and 2k.

On the opposing pair of second sidewalls 2c on the outer surface, there are formed two projections 2m respectively.

Under the respective aforementioned pairs of recesses 2j and 2k, there are formed a pair of supporting members 2p and 2q having arcuate upper surfaces respectively.

The fixed contact member 3 is formed by pressing of conductive metal, and includes a first fixed contact point 3a provided at the central portion, a second fixed contact point 3b disposed in the vicinity of the first fixed contact point 3a, and a third fixed contact point 3c disposed in the vicinity of the first fixed contact point 3a at the position interposing the first fixed contact point 3a with respect to the second fixed contact point 3b.

Defining a set of the first, the second, and the third fixed contact points 3a, 3b and 3c as a fixed contact member 3, two sets of the fixed contact member 3 are disposed alternately with respect to the case 2.

The first fixed contact point 3a includes a first contact portion 3d and the first terminal 3e extending from the first contact portion 3d.

The second fixed contact point 3b includes a second contact portion 3f and the second terminal 3g extending from the second contact portion 3f.

The third fixed contact point 3c includes a third contact portion 3h and the third terminal 3j extending from the third contact portion 3h.

The first contact portion 3d, the second contact portion 3f, and the third contact portion 3h are disposed in such a manner that a part of the respective surfaces are exposed from the bottom wall 2a of the case 2. The first terminal 3e, the second terminal 3g and the third terminal 3j extend respectively outward at the position at almost the same distances from the opposing first sidewalls 2b of the case 2.

A m6vable contact 4 is formed by pressing of a plate material of conductive metal, and includes a flat portion 4a formed on one side and a rising portion 4b extending from one of the ends of the flat portion 4a in a tilted state, and a contact portion 4c extending from one of the ends of the rising portion 4b.

In other words, the movable contact member 4 is formed asymmetrically.

At the boundary between the flat portion 4a and the rising portion 4b, two pairs of locking projections 4d are formed.

The movable contact members 4 are stored and disposed respectively in the two first and the second storage sections 2g and 2h of the case 2 by clamping the pair of supporting members 2p and 2q of the case 2 by the two pairs of locking projections 4d, and are adapted so as to be capable of performing a seesaw movement about the respective first fixed contact points 3a in the first and the second storage sections 2g and 2h respectively. In this case, the respective movable contact members 4 are respectively disposed in the first and the second storage sections 2g and 2h alternately with respect to the case 2 in such a manner that the flat portions 4a are oriented in the opposite directions.

A driving member 5 is formed by molding of an insulative synthetic resin material, and includes an actuating portion 5a formed into a predetermined thickness and being oval in cross section, a pair of projections 5b constituting a cylindrical shaft located at the front end of the actuating portion 5a so as to extend respectively in the direction orthogonal to the opposing surfaces of the actuating portion 5a, and a rectangular column shaped lever portion 5c extending from the distal end portions of one of the projections 5b in parallel with the opposing surfaces of the actuating portion 5a in the direction orthogonal to the extending rear end of the actuating portion 5a and the axial center of the projection 5b.

The pair of aforementioned projections 5b and the lever portion 5c constitute an operating portion for rotating the actuating portion 5a.

The actuating portion 5a, the projection 5b, and the lever portion 5c are extending respectively in the three directions of substantially x-y-z axes.

The projection 5b includes a larger diameter portion 5d provided on the actuating portion 5a side and a smaller diameter portion 5e provided on the side further from the actuating portion 5a.

The lever portion 5c extends from the distal end of the smaller diameter portion 5e on one side so as to be orthogonal thereto.

The smaller diameter portions 5e of the pair of projections 5b of the driving member 5 are disposed in the pair of recesses 2j formed on the upper end of the first and the third sidewalls 2b and 2d of the case 2 respectively and opened on top, and the actuating portion 5a of the driving member 5 is rotatably attached to the case 2.

In other words, the pair of recesses 2j is adapted so that the pair of projections 5b may be fitted from above the case 2. In this case, the width dimensions of the pair of recesses 2j of the first and the third sidewalls 2b and 2d are almost the same as the diameters of the pair of the projections 5b of the driving member 5, and the pair of projections 5b are disposed so as to be capable of moving in the vertical direction in the pair of recesses 2j.

At this moment, the lever portion 5c of the driving member 5 is positioned outside the case 2. so as to face toward the outer wall surface of one of the first sidewalls 2b, and the lever portion 5c is disposed in the vicinity of the stopper 2n.

As described above, although the construction of one of the pairs of recesses 2j and one of the pairs of projections 5b are described, the construction of the other pair of the recesses 2k and the pair of the projections 5b will not be described since the construction is the same except that the respective lever portions 5c are alternately disposed with respect to the case 2 so as to be oriented in the opposite directions.

The spring member 6 as restoring means is formed by pressing of a metallic plate-shaped material having resiliency such as stainless material (SUS), and includes a linear slit 6a, a first and a second spring portions 6b and 6c disposed in parallel on both sides of the slit 6a, a pair of sidewalls 6d extending substantially perpendicularly downward from one of the opposing ends of the first and the second spring portions 6b and 6c, and two through holes 6e provided on both sidewalls 6d.

The first and the second spring portions 6b and 6c includes a plate-shaped holding portion 6f at the respective centers thereof, and tilted portions 6g tilting from the opposing both ends of the holding portions 6f. The slit 6a is formed between the pair of holding portions 6f and the pair of tilted portions 6g.

A switch element set is constructed of the fixed contact member 3, the movable contact member 4, the driving member 5, and the spring member 6 as restoring means (the first or the second spring portion 6b or 6c). The switch element is disposed partly in the first and the second storage sections 2g and 2h respectively, and two switch element sets are disposed in the case 2 alternately with respect to the case 2.

The spring member 6 is disposed in such a manner that the first and the second spring portions 6b and 6c mounted in parallel cover the first and the second openings 2e and 2f formed on top of the case 2 respectively.

The first and the second spring portions 6b and 6c are disposed in such a manner that one of the driving members 5 constituting a part of the two switch element sets is pressed by the first spring portion 6b and the other driving member 5 is pressed by the second spring member 6c.

At this moment, the respective through holes 6e of the pair of sidewalls 6d of the spring member 6 engage the respective projections 2m on the case 2 in a snap-in manner, so that the spring member 6 is reliably attached to the case 2.

In addition, at this moment, free ends of the actuating portions 5a of one and the other driving members 5 pressurize the connecting portion (the flat portion 4a side) between the flat portion 4a and the rising portion 4b of the movable contact member 4, which allows the movable contact member 4 to be brought into contact with the first fixed contact point 3a and the third fixed contact point 3c, so that the portion between the first and the third fixed contact points 3a and 3c is in the ON state and the first fixed contact point 3a and the second fixed contact point 3b is brought out of contact with respect to each other so that the portion between the first and the second fixed contact points 3a and 3b are in the OFF state.

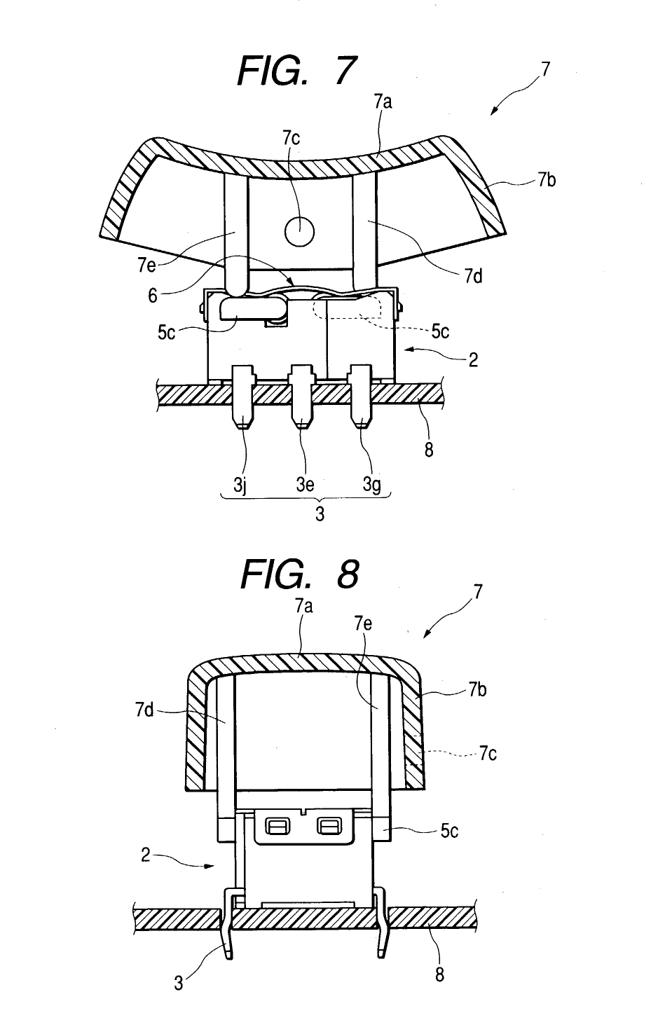

In this state, the switch device is, as shown in FIG. 7 and FIG. 8, is provided with a tab member 7 for operating the switch device disposed above the switch device, for example, on the operating enclosure (not shown) so as to be capable of a swinging motion with respect to the switch device.

Referring to FIG. 7 and FIG. 8, the tab member 7 will now be described.

As shown in FIG. 7 and FIG. 8, the tab member 7 includes an upper wall portion 7a formed by a curved surface, a sidewall portion 7b surrounding four sides of the upper wall portion 7a and having a gentle inclination, a pair of through holes 7c provided at the substantially center of one of the opposing sidewall portions 7b, two operating portions 7d and 7e extending downward from a predetermined alternate portion of the inner surface of the upper wall portion 7a.

The distal ends of these two operation portions 7d and 7e are projecting outward from the lower end of the sidewall portion 7b.

The tab member 7 is attached to, for example, the operating enclosure, not shown, so as to be capable of a swinging motion by a pair of projections (not shown) formed on the operating enclosure inserted into a pair of through holes 7c.

The switch device is attached to a printed wiring substrate 8 by suitable means such as soldering or the like, and the two operating portions 7d and 7e of the tab member 7 are disposed in a state of being in contact with the respective lever portions 5c of the driving members 5 of the switch device.

In other words, the tab member 7 is constructed separately from the switch device and disposed above the switch device by suitable means.

The method of assembly of the switch device according to the invention will be described below.

In the first place, the enclosure 1 having the case 2 and the fixed contact member 3 is placed on a predetermined assembling and transporting jig (not shown) with the upper surface of the first and the second openings 2e and 2f faced upward.

Then, the pair (two) of movable contact members 4 are inserted and disposed on the respective fixed contact members 3. from the first and the second openings 2e and 2f of the case 2 so as to be oriented alternately.

By arranging the respective movable contact members 4 in the case 2, the movable contact members 4 are disposed respectively in the first and the second storage sections 2g and 2h by suitable means, and the substantially centers of the respective movable contact members 4 are placed on the first fixed contact point 3a of the fixed contact member 3 so as to be capable of a seesaw movement.

Subsequently, the actuation portion 5a of the driving member 5 is placed with the free end oriented downward, and the pair of projections 5b are fitted into one and the other pairs of recesses 2j and 2k of the case 2 respectively. In this state, the respective lever portions 5c are disposed outside the respective opposing first sidewalls 2b.

In this state, the free end of the actuating portion 5a is disposed in the vicinity of the connecting portion between the flat portion 4a and the rising portion 4b of the movable contact member 4 in an abutted state.

Subsequently, the first and the second spring portions 6b and 6c of the spring member 6 are disposed so as to cover the first and the second openings 2e and 2f formed on top of the case 2, and the respective through holes 6e on the spring member 6 are engaged with the projections 2h on the case 2 in a snap-in manner, so that.the spring member 6 is mounted on the case 2 (enclosure 1).

In this state, the first and the second spring portions 6b and 6c are attached in a state of slightly pressing the tops (upper portions) of the actuating portions 5a of the respective driving members 5 resiliently toward the bottom wall 2a, and thus in a state in which the free ends (lower portions) of the actuating portions 5a forces the movable contact member 4 to be abutted against the fixed contact member 3 by such resilient pressure.

As described above, the switch device is constructed to be assembled by storing and placing in sequence the movable contact member 4, the driving member 5, and the spring member 6 as restoring means from above into the case 2 (enclosure 1) with the fixed contact member 3 disposed therein.

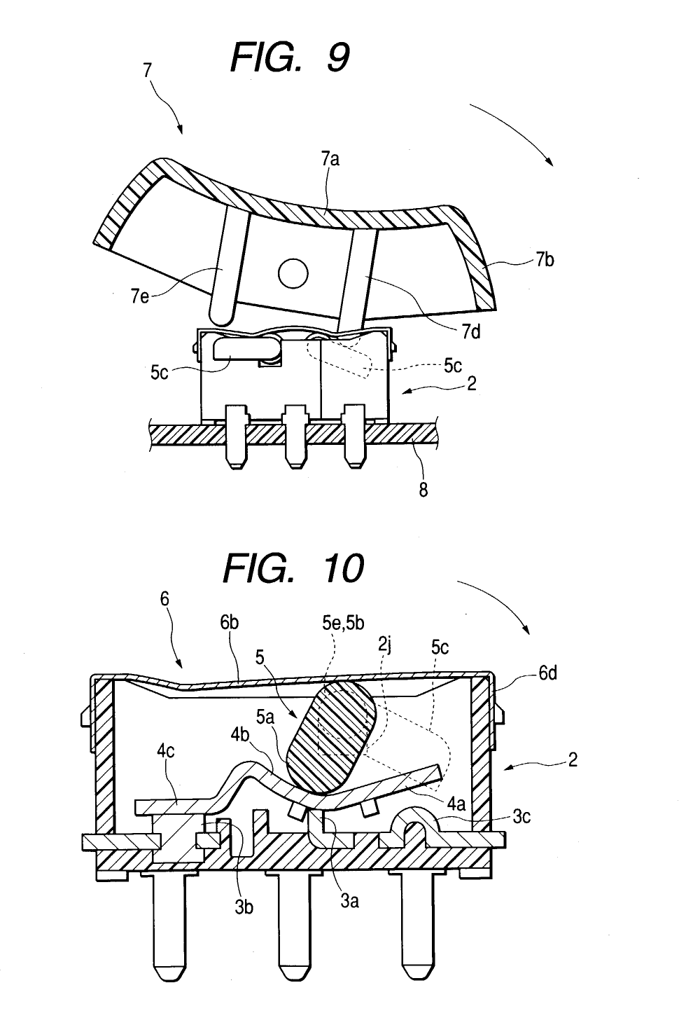

Subsequently, referring to FIG. 9 to FIG. 11, the operation of the switch device according to the invention will be described.

When the tab member 7 is not inclined to any directions and the respective driving members 5 are in the neutral positions as shown in FIG. 7, two switch element sets are such that the respective movable contact members 4 are brought into contact with the first fixed contact points 3a and the third fixed contact points 3c respectively, and the portions between the first and the third fixed contact points 3a and 3c are in the ON state, while the portions between the first fixed contact points 3a and the second fixed contact points 3b are moved away from each other and thus the portions between the first and the second fixed contact points 3a and 3b are in the OFF(non-contact) state, which is the first switched state.

In other words, the two switch element sets disposed alternately (with back side faced to each other) in the case 2 is also in the first switched state.

Subsequently, when the one of the ends (right side in FIG. 7) of the upper wall portion 7a of the tab member 7 is pressed from the state shown in FIG. 7 to rotate the tab member 7 about the through hole 7c clockwise, one of the operating portions 7e of the tab member 7 is moved away from the lever portion 5c of one of the driving members 5 (the lever portion 5c on the front side in FIG. 9), whereby the switch element on the front surface side in FIG. 9 maintains the first switched state.

On the other hand, by rotation of the other operation portion of the tab member 7, the lever portion 5c (lever portion 5c on the rear surface side in FIG. 9) of the other driving member 5 is rotated. By the rotation of the lever member 5c, the actuating portion 5a of the other driving member 5 slides (is displaced) on the rising portion 4b (See FIG. 10) from the flat portion 4a of the other movable contact member 4, and the other movable contact member 4 is rotated about the first fixed contact point 3a. As a consequence, the second switched. state in which the contact portion 4c of the other movable contact member 4 and the second fixed contact point 3b are brought. into contact with each other to the ON state, and the first fixed contact point 3a and the second fixed contact point 3b are moved away from each other to the OFF state (non-contact).

In this state, the pair of projections 5b of the other driving members 5 are adapted to move slightly upward against a resilient force of the spring member 6 in the pair of recesses 2k on the case 2.

In this state, when the switch device is a power-window switch, for example, the motor is switched to the direction to open the window glass.

When the rotational movement of the tab member 7 effected by pressing the tab member 7 is released, the pressure from the actuating portion 5a of the driving member 5 is displaced from the rising portion 4b to the flat portion 4a by a self-restoring force of the spring member 6, and thus the actuating portion 5a is restored to the original position, whereby the other movable contact member 4 moves to restore the first switched state. In this manner, the movable contact member 4 is adapted to perform a seesaw movement.

The pair of projections 5b of the other driving member 5 are constructed to move slightly downward by a res ilient force of the spring member 6 in the pair of recesses 2j of the case 2 in this state.

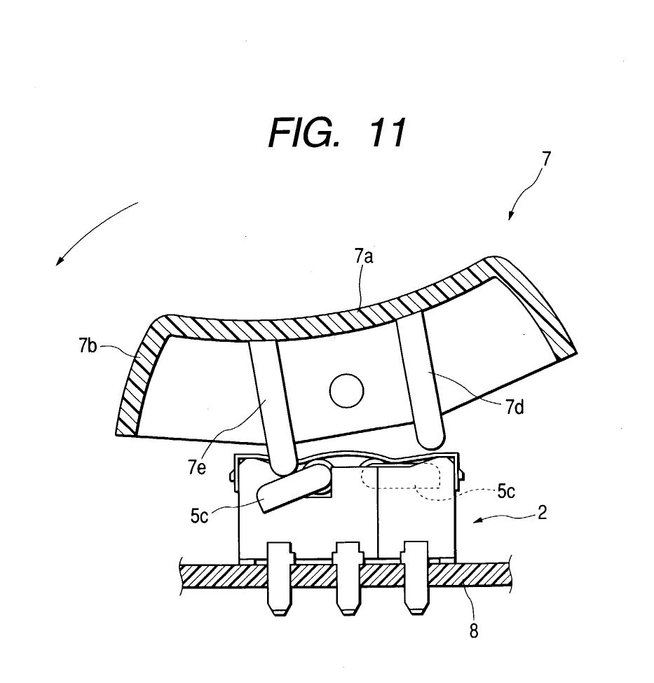

Subsequently, when the other end of the upper wall portion 7a of the tab member 7 (left side in FIG. 7) are pressed and hence the tab member 7 is rotated (See FIG. 11) counterclockwise about the through hole 7c from the state shown in FIG. 7, the other operating portion 7d of the tab member 7 is moved away from the lever portion 5c of the other driving member 5 (the lever portion 5c on the backside in FIG. 11), whereby the switch element on the backside in FIG. 11 is maintained in the first switched state.

Since the action from this state on is almost the same as the series of action of one of the driving members 5, one of the movable contact members 4, and one of the fixed contact members 3 taken when the tab member 7 is rotated counterclockwise, it will not be described here.

In this state, when the switch device is a power window switch, for example, the motor is switched to the direction to close the window glass.

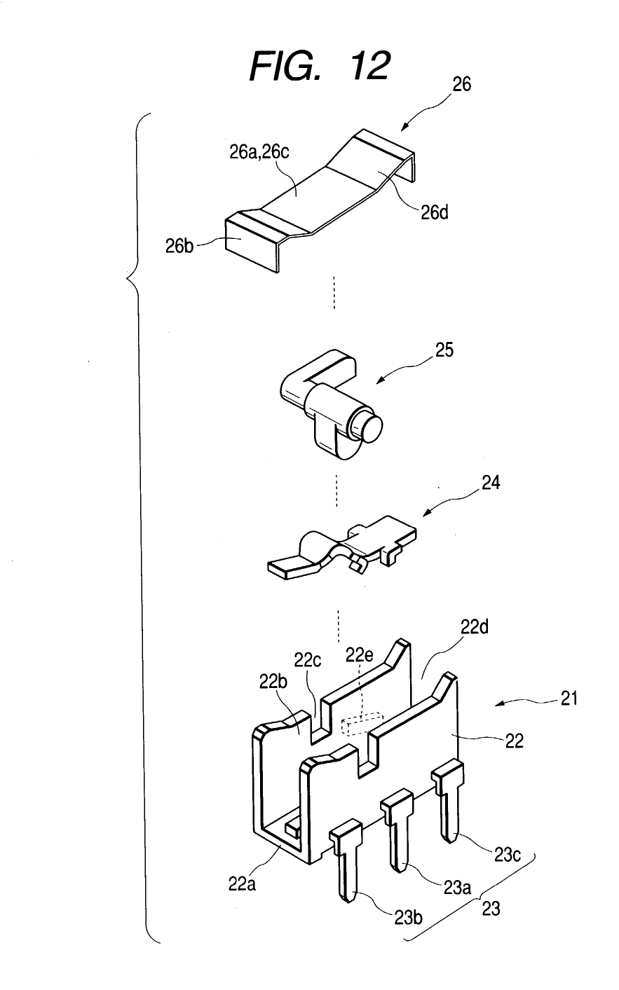

Subsequently, referring to FIG. 12, the second embodiment of the switch device according to the invention will be described.

The switch device is a so-called monopolar/double-throw switch having only a set of switch element.

An enclosure 21 is formed of insulative synthetic resin material, includes a substantially box-shaped case 22 formed by molding, and a set of fixed contact member 23 formed in the case 22 by insert molding of metallic material so as to extend partly outward from the case 22.

The case 22 includes a rectangular bottom wall 22a, a pair of opposing sidewalls 22b extending forward from the bottom wall 22n, a pair of open-top recesses 22c formed at the upper ends of the pair of sidewalls 22b respectively, an opened space 22d defined on the upper side of the pair of sidewalls 22b, and a stopper 22e provided in the vicinity of one of the recesses 22c on the outer side surface of one of the sidewalls 22b.

The pair of recesses 22c are disposed in such a manner that the axial line at the center thereof are coaxially aligned.

The difference in the constructions between the case 22 and the case 2 in the first embodiment described above includes the fact that the case 22 is a monopolar/double-throw switch device having only one switch element set and has one of the sidewalls 22b and the opened space 22d, while the case 2 in the first embodiment is a bipolar/double-throw switch device having two switch element sets, the first and the second sidewalls 2b and 2c surrounding four sides, and two openings 2e and 2f.

Since the fixed contact member 23 has the same construction and layout as the fixed contact member 3 described in conjunction with the first embodiment described above, detailed description will not be made. The fixed contact member 23 is constructed only of one set, and includes a set of the first, the second, and the third terminals 23a, 23b and 23c as a part of the construction.

Since a movable contact member 24 and the driving member 25 have the same construction and layout as the movable contact member 4 and the driving member 5 described in conjunction with the first embodiment described above, as in the case of the fixed contact member 23, detailed description will not be made.

A spring member 26 as restoring means is formed by press molding of a resilient metallic plate material, and includes a spring portion 26a, a pair of sidewalls 26b extending. substantially vertically downward from one of the opposing ends of the spring portion 26a, and two through holes (not shown) disposed on each sidewalls.

The spring member 26a includes a plate-shaped holding portion 26c, and a pair of tilted portion 26d tilting from the holding portion 26c.

The spring member 26 is disposed so that the spring portion 26a covers the opened space 22d formed on the case 22, and respective through holes (not shown) formed on the spring member 26 engage the opposing end surfaces of the respective sidewalls 22b by suitable means such as snap engagement and the like so that attachment of the spring member 26 to the case 22 is ensured.

As regards description of a method of assembly and of the action of the switch device according to the second embodiment, such method of assembly and the action are almost the same as the method of assembly and the action of the switch device according to the first embodiment described above, and thus detailed description will not be made.

The difference of the action of the switch device according to the second embodiment from the action of the switch device according to the first embodiment is that the tab member 7 (See FIG. 7) on the switch device according to the first embodiment is adapted to be capable of swinging in the clockwise and the counterclockwise directions in order to activate the alternately disposed two switch element sets by the action of the switch device, while the tab member 7 on the switch device according to the second embodiment is disposed so as to be capable of swinging only in one of the clockwise and the counterclockwise directions in order to activate one switch element set.

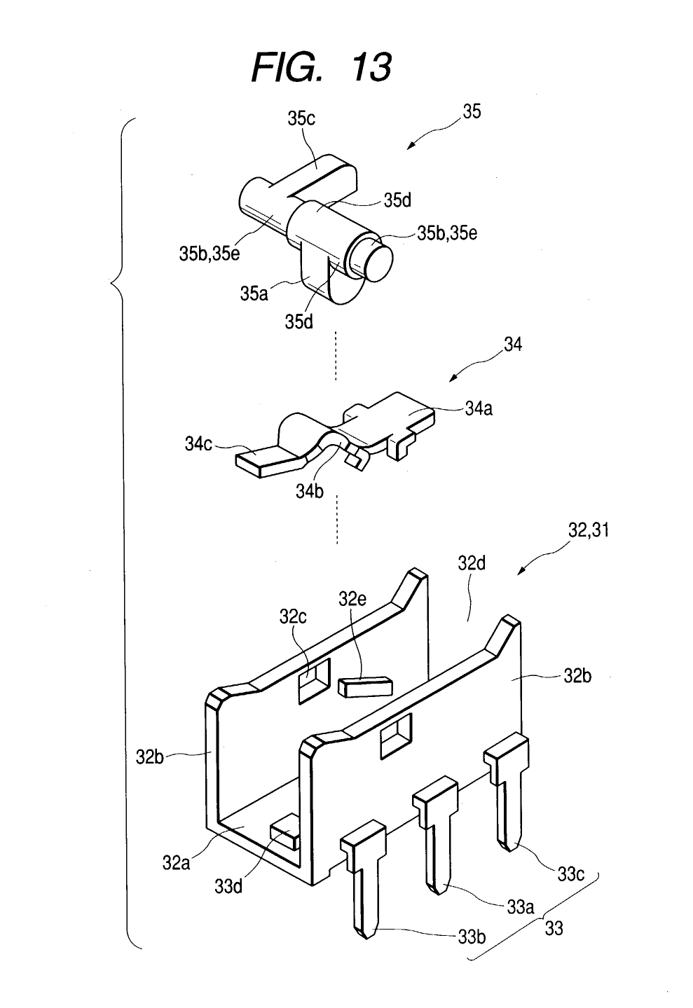

Referring now to FIG. 13, the third embodiment of the switch device according to the invention will be described. The switch device is a so-called monopolar/double-throw switch device having only one switch element set.

As shown in FIG. 13, an enclosure 31 is formed of insulative synthetic resin material, and includes a substantially box-shaped case 32. formed by molding, and a set of fixed contact member 33 formed by insert molding in the case 32 of metallic material so as to extend partly outward from the case 32.

The case 32 includes a rectangular bottom wall 32a, a pair of opposing sidewalls 32b extending vertically forward from one of the opposinq outer peripheral ends of the bottom wall 32a, a pair of through holes 32c formed on the pair of sidewalls 32b at prescribed coaxial positions respectively, an opened space 32d provided upwardly thereof, and a stopper 32e formed on the inner side surface of one of the sidewalls 32b in the vicinity of one of the through holes 32c.

A pair of through holes 32c of the sidewall 32b of the case 32 constitutes, so-called the recess described above.

Since the fixed contact member 33 has the same construction and layout as the fixed contact member 3 of the switch device according to the first embodiment described above, detailed description will not be made.

A fixed contact member 33 is constructed only of a set, and includes a set of a first, a second and a third terminals 33a, 33b and 33c as a part of the construction.

Since a movable contact member 34 has almost the same construction as the movable contact member 4 of the switch device according to the first embodiment described above, detailed description will not be made.

The difference between the movable contact member 34 and the movable contact member 4 described above is that the movable contact member 34 is formed by pressing of resilient conductive metal, while the movable contact member 4 described above is formed of a hard conductive metal.

The movable contact member 34 includes a flat portion 34a, a rising portion 34b and a contact portion 34c.

Since the movable contact member 34 having resiliency is formed of a resilient conductive metal, the contact portion 34c is formed so as to be deformed and moved to be bent from the rising portion 34b by its resiliency.

In other words, the movable contact member 34 having a resiliency constitutes restoring means for restoring the driving member 35 that will be described later to its original position.

The movable contact member 34 is disposed in the case by suitable means so as to be capable of a seesaw movement about the first fixed contact point (not shown) in the case 32.

In this case, the contact portion 34c of the movable contact member 34 is disposed opposingly to the second contact point 33d, and the flat portion 34a is disposed opposingly to the third fixed contact point (not shown).

Since the driving member 35 is formed in almost the same construction as the driving member 5 of the switch device according to the first embodiment described above, detailed description will not be made.

Here, the difference in construction of the driving member 35 from the driving member 5 of the first embodiment will be described.

The driving member 35 includes an actuating portion 35a, a pair of projections 35b, and a lever portion 35c, and each of the respective projections 35b includes a larger diameter portion 35d and the smaller diameter portion 35e.

The length of one of the smaller diameter portions 35e of the projections 35b is longer than the length of the other smaller diameter portion 35e, and the lever portion 35c extends from the substantially center of one of the smaller diameter portions 35e in the direction orthogonal to the axial center of the projection 35b.

The driving member 35 is disposed in such a manner that the respective distal ends of the respective smaller diameter portions 35e of the pair of projections 35b are inserted into the pair of through holes 32c on the case 32, whereby the actuating portion 35a can rotate.

In this state, the distal end of the operating portion 35a is in abutment with the surface in the vicinity of the connecting portion between the flat portion 34a and the rising portion 34b.

The lever portion 35c of the driving member 35 is disposed in the vicinity of the one of the pair of the sidewalls 32b of the case 32.

As is described above, the switch device according to the third embodiment includes three members of; the enclosure 31 having the case 32 and a set of fixed contact member 33, a single piece of the movable contact member 34 and a single piece of the driving member 35. In other words, a switch element set is constructed of a set of fixed contact member 33, a single piece of the movable contact member 34, and a single piece of the driving member 35.

Subsequently, a method of assembling the switch device according to the third embodiment will be described.

The enclosure 31 having the case 32 and the fixed contact member 33 is placed on a predetermined assembling and transporting jib (not shown) with the opened space 32d faced upward.

Subsequently, the movable contact member 34 is inserted and disposed from the opened space 32d of the case 32 on the respective fixed contact member 33 in a predetermined orientation.

Then, a predetermined assembling jig (not shown) for widening the initial width of the opened space 32d of the case 32 to a predetermined width is disposed on the opened space 32d, and the width of the opened space 32d is widened to a predetermined width, by this assembling jib.

Subsequently, in a state in which the width of he opened space 32d is widened, the respective smaller diameter portions 35e of the pair of projections 35b are inserted and disposed into the respective through holes 32c on the sidewalls 32b of the case 32 with the free end of the actuating portion 35a of the driving member 35 faced downward.

Then, the assembling jib for widening the width of the opened space 32d into the predetermined width is removed to restore the width of the opened space 32d to the original width.

By restoring the width of the opened space 32d to the original width, the respective smaller diameter portions 35e of the pair of projections 35b are reliably inserted and disposed into the respective through holes 32c.

In this state, the lever portion 35c of the driving member 35 is disposed in parallel with the surface of the bottom wall 32a and disposed in the vicinity of the stopper 32e of the case 32.

The free end of the actuating portion 35a of the driving member 35 abuts against and is disposed on the movable contact member 34.

The action of the switch device according to the third embodiment will be described.

Before operating the switch device, the lever portion 35c of the driving member 35 is in parallel with the bottom wall 32a, and as in the case of the switch device according to the first embodiment described above, the driving member 35 is placed at the neutral position. The switch element is in the first switched state in which the movable contact member 34 is in contact with the first fixed contact point 33a and the third fixed contact point 33c so that the portion between the first and the third fixed contact points 33a and 33c is in the ON (contact) state, and the first and the second fixed contact points 33a and 33b are moved away from each other so that the portion between the first fixed contact point 33a and the second fixed contact point 33b is in the OFF (non-contact) state.

Subsequently, when the lever portion 35c of the driving member 35 is rotated in the clockwise direction by suitable means from this state, the rotation of the lever portion 35c allows the actuating portion 35a to slide (to be displaced) from the flat portion 34a of the movable contact member 34 over the rising portion 34b to rotate the movable contact point 34 about the first fixed contact point 33a, and the resilient rising portion 34b to be displaced resiliently. Consequently, the second switched state in which the contact portion 34c of the movable contact member 34 and the second fixed contact point 33b are brought into contact with each other to the ON state, and the first fixed contact point 33a and the second fixed contact point 33b are moved away from each other to the OFF (non-contact) state is achieved.

In this state, since the pair of projections 35b of the driving member 35 are inserted into the pair of through holes 32c constituting the so-called recess, the driving member 35 is adapted to rotate about the axial centers of the pair of projections 35b.

Then, when the rotational movement effected by pressing the lever portion 35c is released, the pressure from the actuating portion 35a of the driving member 35 is displaced from the rising portion 34b to the flat portion 34a by a self-restoring force of the resilient movable contact member 34 so that the original position is restored, and the restoration of the original position returns the movable contact member 34 to the first switched state.

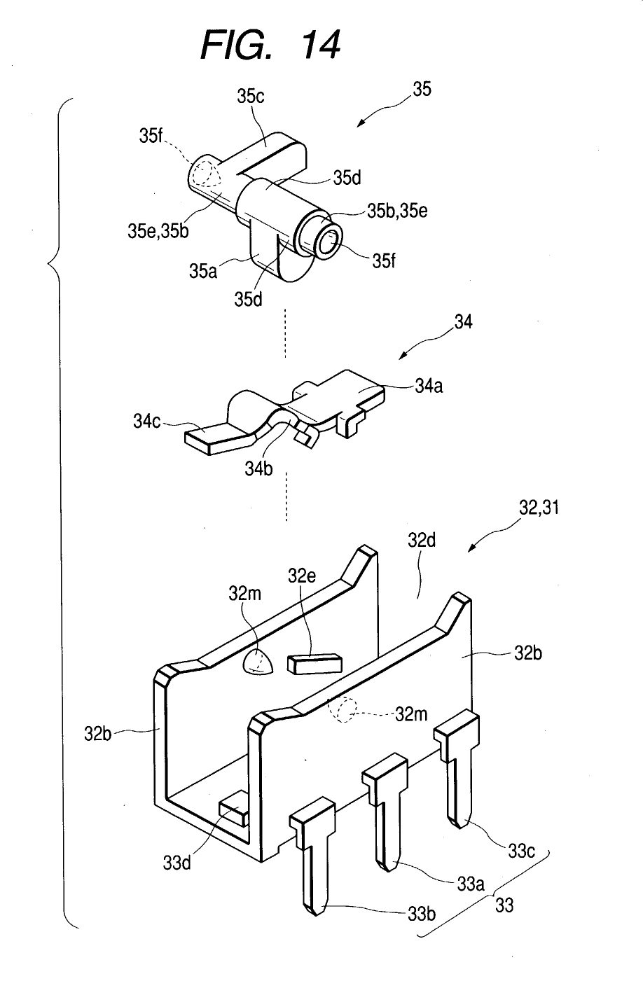

Referring to FIG. 14, the fourth embodiment of the switch device according to the invention will be described. The switch device is a so-called monopolar/double-throw switch device having only one switch element set.

As shown in FIG. 14, the basic construction of the switch device in the fourth embodiment is the almost the same construction as the switch device of the third embodiment described above, the same construction is represented by the same reference numerals and detailed description will not be made.

Accordingly, the switch device according to the fourth embodiment will be described only about the difference from the switch device according to the third embodiment.

The difference is as follows. In the case of the switch device according to the third embodiment described above, the pair of through holes 32c constituting the recesses are formed on the sidewalls 32b of the case 32 and the pair of projections 35b are formed on the driving member 35. In addition, the pair of projections 35b of the driving member 35 are disposed in the pair of through holes 32c of the case 32.

On the other hand, in the case of the switch device according to the fourth embodiment, a pair of projections 32m is formed on the opposing inner surfaces of the sidewalls 32b of the case 32, and a pair of recesses 35f are formed at the distal ends of the respective smaller diameter portions 35e of the pair of projections 35b of the driving member 35 coaxially with the respective smaller diameter portions 35e. The pair of projections 32m of the case 32 are disposed in the pair of recesses 35f of the driving member 35.

The switch device according to the third embodiment and the switch device according to the fourth embodiment differ from each other in that the recess and the projection are disposed in the different manners.

Since the method of assembly and the action of the switch device according to the fourth embodiment is almost the same as the switch device according to the third embodiment described above, the description will not be made.

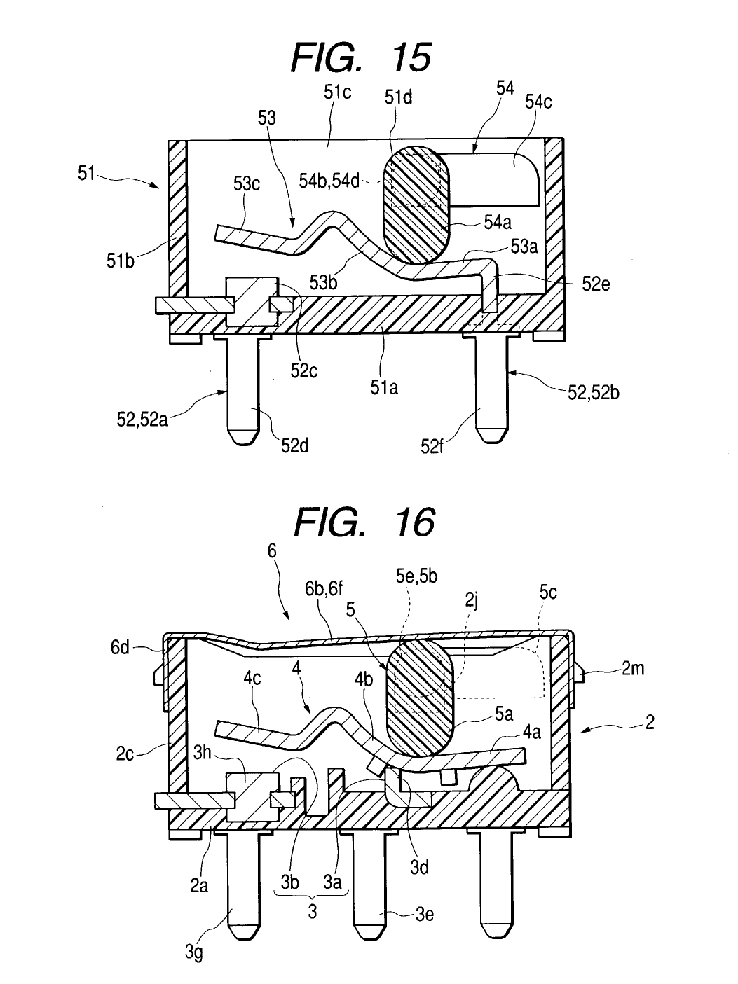

Subsequently, referring to FIG. 15, the fifth embodiment of the switch device according to the invention will be described.

This switch device will be described as a monopolar/single-throw switch device having a switch element set.

As shown in FIG. 15, a case 51 includes a rectangular bottom wall 51a, a sidewall 51b extending from the bottom wall 51a and surrounding four sides, an opening 51c formed on top of the sidewall 51b, and a pair of holes 51d provided coaxially on one of the opposing sidewalls 51b.

A fixed contact member 52 includes a first fixed contact point 52a, and a second fixed contact point 52b disposed away from the first fixed contact point 52a by a predetermined distance.

The first fixed contact point 52a includes a first contact portion 52c and a first terminal 52d extending from the first contact portion 52c.

The second fixed contact point 52b includes a second contact portion 52e and a second terminal 52f extending from the second contact portion 52e.

The fixed contact member 52 constructed of the first fixed contact point 52a and the second fixed contact point 52b is insert molded on the bottom wall 51a of the case 51, and the first contact portion 52c and the second contact portion 52e are disposed so as to be exposed from the inner wall surface of the bottom wall 51a.

The movable contact member 53 is formed of a resilient plate material of conductive metal, and includes a flat portion 53a formed on one of the end side, and a rising portion 53b extending from one of the ends of the flat portion 53a in a tilted manner, and a contact portion 53c extending from one of the ends of the rising portion 53b.

In other words, the movable contact member 53 is formed into an asymmetric shape.

One of the ends of the flat portion 53a is continuing from the second contact portion 52e of the second fixed contact point 52b, whereby the movable contact member 53 is integrated with the second fixed contact point 52b. In this case, the movable contact member 53 is disposed in the sidewall 51b surrounding four sides opposingly to the bottom wall 51a, and the contact portion 53c is disposed at the position away from (non-contact) the first contact portion 52c of the first fixed contact point 52a.

Since the resilient movable contact member 53 is formed of a resilient conductive metal, for example, the contact portion 53c is formed so as to be deformed and moved to be bent from the rising portion 53b by its resiliency.

In other words, the movable contact member 53 having a resiliency constitutes restoring means for restoring a driving member 54 that will be described later to its original position.

The driving member 54 has almost the same construction as the driving member 34 of the switch device according to the third embodiment described above, and includes an actuating portion 54a, a pair of projections 54b and a lever portion 54c, and each of the respective projections 54b includes a larger diameter portion (not shown) and a smaller diameter portion 54d.

The length of the smaller diameter portion 54d of one of the projections 54b is longer than the length of the other smaller diameter portion (not shown), and the lever portion 54c extends from the substantially center of one of the smaller diameter portions 54d in the direction orthogonal to the axial center of the projection 54b.

The switch device according to the fifth embodiment is constructed of two members; one of the members is constructed of the case 51, the fixed contact member 52 and the movable contact member 53, and the other one of the members is constructed of the driving member 54.

Subsequently, the action of the switch device according to the fifth embodiment will be described.

Since the switch device is constructed of the second fixed contact point 52b of the fixed contact member 52 and the flat portion 53a of the movable contact member 53 integrally continuing with each other as described above, the second fixed contact point 52b and the movable contact member 53 are constantly conducted (ON: contact) irrespective of whether or not the driving member 54 is not in operation or in operation.

The action of the lever portion 54c of the driving member 54 when not in operation will be described here. The actuating portion 54a of the driving member 54 is disposed perpendicularly with respect to the bottom wall 51a, and the free end of the actuating portion 54a is in abutment with the flat portion 53a of the movable contact member 53. In this case, the contact portion 53c of the movable contact member 53 is away from the first fixed contact point 52a of the fixed contact member 52, and thus the switch element is in the OFF (non-contact) state.

The action of the lever portion 54c of the driving element 54 when in operation will be described now. When the lever portion 54c rotates in the clockwise by the operation of a tab member (not shown) disposed above the switch device, the free end of the actuating portion 54a moves along the tilted surface from the flat portion 53a to the rising portion 53b being tilted.

By the movement of the actuating portion 54a, the resilient rising portion 53b rotates counterclockwise about the flat portion 53a (pressed downward), and the rotation (pressed downward) of the rising portion 53b allows the contact portion 53c to be brought into contact with the first fixed contact point 52a (first contact portion 52c) of the fixed contact member 52, whereby the switch element is brought into the ON (contact) state.

When the operation of the tab member (not shown) is released, the actuating portion 54a is displaced from the rising portion 53b and restored to the original position by a resilient force (restoring force) of the movable contact member 53, and the contact portion 53c is moved away from the first fixed contact point 52a, whereby the switch element is brought into the original OFF (non-contact) state. When the actuating portion 54a is restored to its original position, the lever potion 54c rotates counterclockwise.

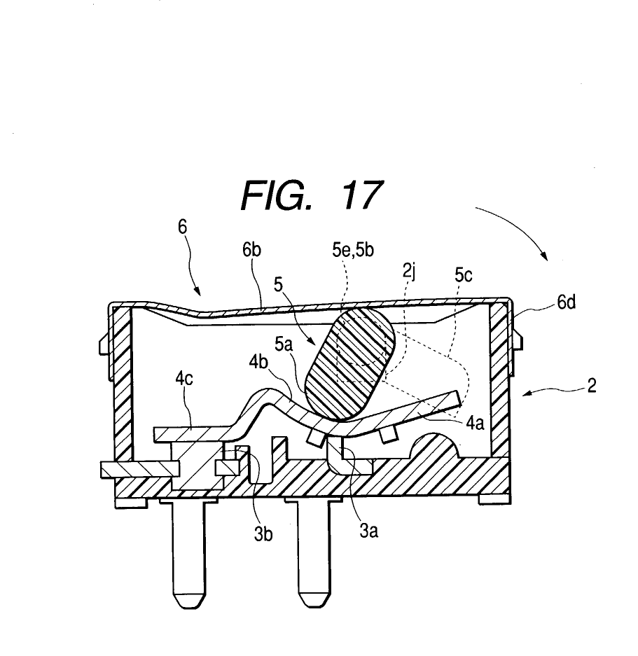

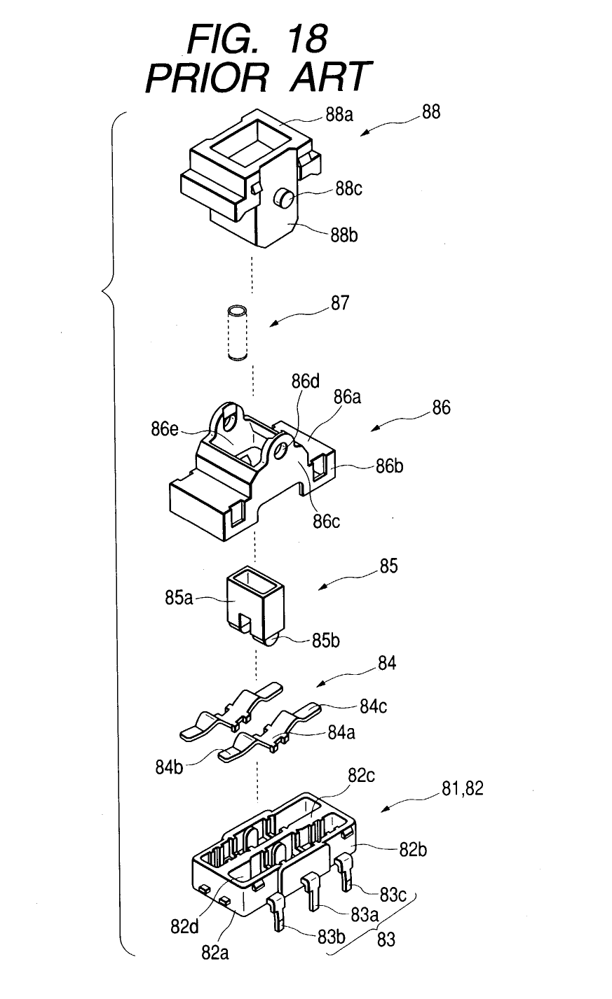

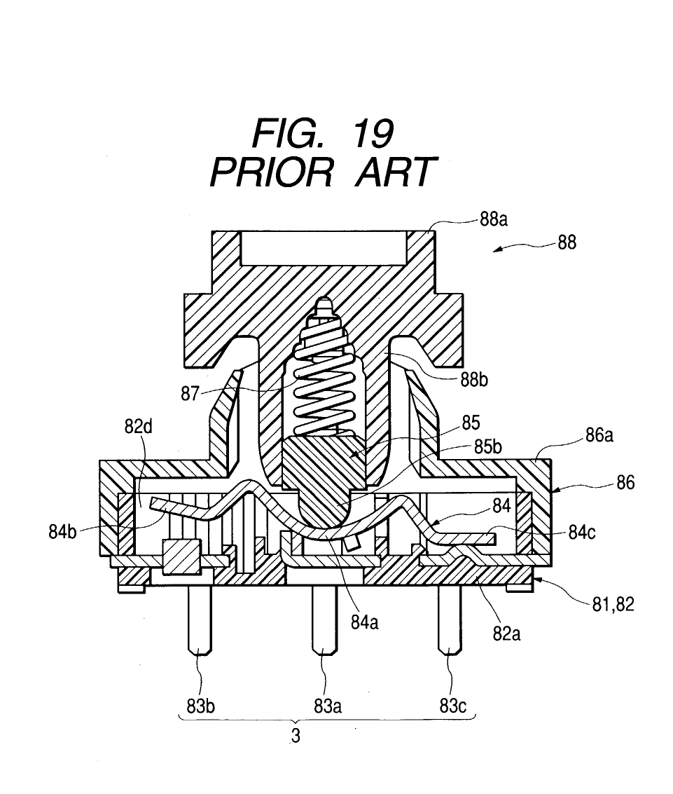

Referring now to FIG. 16 and FIG. 17, the sixth embodiment of the switch device according to the invention will be described.

This switch device is described as a monopolar/single-throw switch device having a switch element set. In this switch device, the same components as the switch device according to the first embodiment described above will be represented by the same reference numerals and will not be described here.

Here, the difference in construction between the switch device according to the first embodiment described above and the switch device according to the sixth embodiment will be described.

The difference is such that the fixed contact member 3 includes the first, the second and the third fixed contact points 3a, 3b and 3c, and the first, the second and the third terminals 3e, 3g and 3j of the first, the second and the third fixed contact point 3a, 3b and 3c respectively in the switch device according to the first embodiment, while the fixed contact member 3 includes only the first and the second fixed contact points 3a and 3b, and the first and the second terminals 3e and 3g respectively of the first and the second fixed contact point 3a and 3b in the switch device according to the sixth embodiment.

In other words, the switch device according to the sixth embodiment is not provided with the third fixed contact point 3c.

In this arrangement, the monopolar/single-throw switch device is constructed.

Although the switch device is described as a monopolar/single-throw switch device here, it is applicable as a matter of course to dispose two of these switch devices in parallel to form a bipolar/single-throw switch device.

The action of the switch device according to the sixth embodiment is almost the same as the action of the bipolar/double-throw switch device in the first embodiment described above, and the difference is only that the switch device according to the sixth embodiment is a single-throw switch device as described above. Therefore, description will not be made here.

Although the restoring means in the embodiments described above is formed by a plate-shaped resilient spring member, it is not limited thereto, and the restoring means may be formed of a resilient member such as rubber or of a wire spring or the like.

As described thus far, the switch device according to the invention includes: a case having a bottom wall and at least an opposing pair of sidewalls extending from the bottom wall; a fixed contact member provided on the bottom wall of the case; a movable contact member disposed in the case; a driving member rotatably mounted on the pair of sidewalls; restoring means for restoring the driving member to the original position; and the driving member including an actuating portion for moving the movable contact member and an operating portion for rotating the actuating member, and is constructed in such a manner that the actuating portion is rotated when the operating portion of the driving member is driven and hence the actuating portion moves the movable contact member so that the movable contact member is brought into contact with a fixed contact member, and the driving member is restored to the original position in which the movable contact member and the fixed contact member are brought out of contact by restoring means when the driven state of the operating portion is released. Accordingly, since the number of components is small, and it can be assembled by stacking the components in sequence from above, a switch device that can easily be assembled and is downsizable is provided.

Since the switch device according to the invention is constructed in such a manner that the driving member is urged by the spring member toward the bottom wall, and the driving member is restored to the original state by an urging force of the spring member, the layout and the operations of the driving member and the spring member are simple, and thus the switch device which is simple in construction and hence is cost-effective may be provided.

Since the switch device according to the invention is constructed in such a manner that that the driving member moves away from the bottom wall against an urging force of the spring member when the actuating portion of the driving member urged by the spring member toward the bottom wall rotates, and simultaneously, the driving elements rotate so that the actuating portion moves the movable contact member to bring the movable contact member and the fixed contact member into contact with each other, while the driving member is restored to the original state by the spring member to bring the movable contact member out of contact with the fixed contact member when the rotation of the driving member is released, the action of the spring member is simple, whereby the switch device in which the driving member being capable of being operated smoothly and having a stable performance may be provided.

Since the switch device of the invention is constructed in such a manner that the operating portion of the driving member is positioned outside the case and the stopper isdisposed outside the case, so that the operating portion abuts against the stopper to limit the rotational movement thereof, the operating portion is positioned outside the case, whereby the switch device in which the operation of. the operating portion may be facilitated and thus the operation and the construction are simple is provided.

Since the switch device according to the invention is constructed in such a manner that the driving member is formed with a projection, and the case is formed with a recess, and that the projection is disposed into the recess so that the driving member is rotatably mounted to the case, it is easier to form the projection on the driving member and the recess on the case, whereby the cost-effective switch device that can easily be assembled is provided.

Since the switch device according to the invention is constructed in such a manner that the recess on the sidewall is formed to have an almost same width as the diameter of the recess on the driving member, and the projection is adapted to be movable in the vertical direction in the recess, the projection of the driving member is movable in the vertical direction in the recess, whereby the switch device in which the projection is not subject to an excessive force and a stable performance may be maintained for a long time is provided.

The switch member according to the invention is constructed in such a manner that the movable contact member performs a seesaw movement by the pressure of the actuating portion being displaced from the flat portion to the rising portion so that the movable contact member is brought into contact with the fixed contact member, and performs a seesaw movement to be restored to the original state by the pressure of the actuating portion being displaced from the rising portion to the flat portion so that the movable contact member is brought out of contact with the fixed contact member, the seesaw movement of the movable contact member may be performed by a simple action of the actuating portion of the driving member, whereby the switch device ensuring a reliable action is provided.

The switch device of the invention is constructed in such a manner that the fixed contact member includes the third fixed contact point, and the movable contact member is brought into contact with the first fixed contact point and the third fixed contact point and thus the portion between the first and the third fixed contact points is in the ON state when the driving member is not in operation, while the flat portion of the movable contact member is brought out of contact with the third fixed contact point and thus the portion between the first and the third fixed contact points is in the OFF state, and simultaneously the movable contact member is bought into contact with the second fixed contact point so that the portion between the first and the second fixed contact points is in the ON state when the driving member is actuated, whereby the cost-effective monopolar/double-throw switch device including the small number of components is provided.

The switch device according to the invention is constructed in such a manner that a switch element set is constructed of the fixed contact member, the movable contact member, the driving member, and the restoring means and two switching element sets are disposed in parallel in the case, whereby the cost-effective bipolar/double-throw switch device including small number of components and thus being easy to assemble is provided.

The switch device according to the invention is constructed in such a manner that the two movable contact members constituting a part of two sets of switching elements are disposed alternately with respect to the case so that the flat portions of the respective movable contact members are oriented in the opposite directions. Accordingly, since the asymmetric two movable contact members are disposed alternately with respect to the case, the longitudinal dimension of the case may be shortened, whereby the downsizable switch device is provided.

What is claimed is:

1. A switch device comprising:
a case having a bottom wall and at least an opposing pair of sidewalls extending from the bottom wall;
a fixed contact member provided on the bottom wall of the case;
a movable contact member disposed in said case;
a driving member rotatably mounted on said pair of sidewalls; and
restoring means for restoring said driving member to the original position, and
said driving member including an actuating portion for moving said movable contact member and an operating portion for rotating the actuating portion,
wherein said actuating portion is rotated when said operating portion of said driving member is driven and hence said actuating portion moves said movable contact member so that said movable contact member is brought into contact with said fixed contact member, and said driving member is restored to the original state in which said movable contact member and said fixed contact point are brought out of contact by said restoring means when the driven state of said operating portion is released.

2. A switch device according to claim 1, wherein said restoring means is constructed of a spring member.

3. A switch device according to claim 2, wherein said driving member is urged by said spring member toward said bottom wall, and said driving member is restored to the original state by an urging force of said spring member.

4. A switch device according to claim 3, wherein said spring member is formed of a plate having spring characteristics.

5. A switch device according to claim 3, wherein said case includes a sidewall surrounding four sides and an opening formed on top thereof, and wherein the opening is covered by said spring member formed of said plate.

6. A switch device according to claim 3, wherein said spring ember is snap engaged with said sidewall of said case.

7. A switch device according to claim 3, wherein said driving member moves away from said bottom wall against an urging force of said spring member when said actuating portion of said driving member rotates, and simultaneously, said driving member rotates so that said actuating portion moves said movable contact member to bring said movable contact member and said fixed contact member into contact with each other, while said driving member is restored to the original state by said spring member to bring said movable contact member out of contact with said fixed contact member when the rotation of said driving member is released.

8. A switch device according to claim 1, wherein said case is provided with a stopper for limiting the rotatable range of said operating portion of said driving member.

9. A switch device according to claim 8, wherein said operating portion of said driving member is positioned outside said case and said stopper is disposed outside said case, so that said operating portion abuts against said stopper to limit the rotational movement thereof.

10. A switch device according to claim 1, further comprising a projection on one of said driving member and one of said opposing sidewalls of said case, and a recessed portion on the other one of them and said projection in said recess, wherein said driving member is rotatably mounted on said case.

11. A switch device according to claim 10, wherein said driving member is formed with said projection, said case is formed with said recess, and said projection is disposed into said recess so that said driving member is rotatably mounted to said case.

12. A switch device according to claim 11, wherein the upper end of said sidewall includes said recess opened on top, and said projection is fitted into said recess from above.

13. A switch device according to claim 12, wherein said recess on said sidewall is formed to have almost the same width as the diameter of said projection on said driving member, and said projection is adapted to be movable in the vertical direction in said recess.

14. A switch device according to claim 1, wherein said movable contact member includes a flat portion, a rising portion extending from one of the ends of the flat portion in a tilted state, and a contact portion extending from one of the ends of the rising portion and coming into and out of contact with said fixed contact member, and said movable contact member is supported so as to be capable of a seesaw movement.

15. A switch member according to claim 14, wherein said movable contact member performs a seesaw movement by the pressure of said actuating portion being displaced from said flat portion to said rising portion so that said movable contact member is brought into contact with said fixed contact member, and performs a seesaw movement to be restored to the original state by the pressure of said actuating portion being displaced from said rising portion to said flat portion so that said movable contact member is brought out of contact with said fixed contact member.

16. A switch member according to claim 14, wherein said fixed contact member is constantly in contact with said movable contact point, and includes a first fixed contact point for supporting said movable contact member, and a second fixed contact point for coming into and out of contact with said movable contact member, and wherein said movable contact member is adapted to perform a seesaw movement about said first fixed contact point.

17. A switch device according to claim 16, wherein said fixed contact member includes a third fixed contact point, and said movable contact member is brought into contact with said first fixed contact point and said third fixed contact point and thus the portion between said first and said third fixed contact points is in the ON state when said driving member is not in operation, while said flat portion of said movable contact member is brought out of contact with said third fixed contact point and thus the portion between said first and said third fixed contact points is in the OFF state, and simultaneously said movable contact member is bought into contact with said second fixed contact point so that the portion between said first and said second fixed contact points is in the ON state when said driving member is actuated.

18. A switch device according to claim 1, wherein a switch element set is constructed of said fixed contact member, said movable contact member, said driving member, and said restoring means, and two switching element sets are disposed in parallel in the case.

19. A switch device according to claim 18, wherein said two movable contact members constituting a part of said two switching element sets are disposed alternately with respect to said case so that said flat portions of said respective movable contact members are oriented in the opposite directions.

20. A switching device according to claim 18, further comprising said spring member formed of a plate, wherein said spring member includes a slit and a first and a second spring portions located at both sides of the slit, wherein the first and the second spring portions are disposed so as to cover the upper portion of said case, and wherein one of said driving member constituting a part of said two switching elements is pressurized by said first spring portion and said other driving member is pressurized by said second spring portion.
